(19) United States
(12) Patent Application Publication
(10) Pub. No.: US 2024/0424931 A1
(43) Pub. Date: Dec. 26, 2024

(54) METHOD OF OBTAINING VEHICLE INFORMATION DURING SLOW CHARGING OF ELECTRIC VEHICLE CHARGER, METHOD AND SYSTEM FOR CHARGING ELECTRIC VEHICLE USING SAME

(71) Applicants: Hyundai Motor Company, Seoul (KR); Kia Corporation, Seoul (KR); HchargeLab Inc., Suwon-si (KR)

(72) Inventors: Hotaek Lee, Seoul (KR); Min Kyu Lee, Yongin-si (KR); Young Hoon Moon, Seoul (KR)

(21) Appl. No.: 18/496,032

(22) Filed: Oct. 27, 2023

(30) Foreign Application Priority Data
Jun. 22, 2023 (KR) 10-2023-0080527

(51) Int. Cl. B60L 53/30; B60L 53/10; B60L 53/60

(52) U.S. Cl. CPC B60L 53/305; B60L 53/11; B60L 53/60

(57) ABSTRACT

In an embodiment, a method is provided of obtaining vehicle information during AC (slow) charging of an electric vehicle charger, and a method and system for charging an electric vehicle using the method is also provided. The method of obtaining vehicle information during slow charging of an electric vehicle charger can include transmitting a DC method as charging method information to the electric vehicle through power line communication (PLC), obtaining vehicle information from the electric vehicle, terminating PLC with the electric vehicle and performing AC charging of the electric vehicle on the basis of pulse width modulation (PWM) communication, terminating the PWM communication with terminating AC charging, and resuming PLC to obtain vehicle information from the electric vehicle.

### CROSS-REFERENCE TO RELATED APPLICATIONS

This application claims the benefit of Korean Patent Application No. 10-2023-0080527, filed on Jun. 22, 2023, which application is hereby incorporated herein by reference.

### TECHNICAL FIELD

The present disclosure relates to charging of an electric vehicle.

### BACKGROUND

Unlike rapid charging, which requires DC charging and power transfer control, in the case of slow charging, an on-board charger (OBC) in a vehicle performs charging control, and thus conventional electric vehicle slow chargers require only low-level communication using pulse width modulation (PWM) signals defined in ISO 15118.

However, in recent years, various types of vehicle data are required to improve the convenience of chargers, and as a power distribution function such as V2X (V2G and V2H) is required to be applied to chargers, development of a slow charger to which high-level communication using power line communication (PLC) is applied is required.

As described above, most mass-produced electric vehicles or electric vehicles currently in mass production are designed such that they do not support power line communication (PLC) for slow charging in an electric vehicle charging controller (EVCC), whereas electric vehicles currently in development are designed to support PLC even during slow charging.

Therefore, electric vehicles capable of power line communication during slow charging and electric vehicles incapable of power line communication will inevitably be mixed in the market in the future, and development of a general-purpose slow charger that can acquire vehicle information and perform slow charging by being applied to both electric vehicles supporting PLC and electric vehicles that do not support PLC is required.

This background art is technical information that the inventor possessed for derivation of the present invention or acquired during a process of deriving the present invention, and cannot necessarily be called known art as defined in the patent statute.

### SUMMARY

The present disclosure relates to charging of an electric vehicle, and more particularly, to a method of obtaining vehicle information during slow charging of an electric vehicle charger, and a method and system for charging an electric vehicle using the same.

Embodiments disclosed in the present disclosure have been devised in view of the above circumstances, and an embodiment of the present disclosure provides a method of obtaining vehicle information during slow charging of an electric vehicle charger, in which vehicle information can be obtained before slow charging of a vehicle is performed even for a vehicle that does not support power line communication (PLC), and a method and system for charging an electric vehicle using the method.

In addition, an embodiment provides a method of obtaining vehicle information during slow charging of an electric vehicle charger, in which vehicle information can be obtained before slow charging of a vehicle is performed even in a situation in which it is not possible to ascertain whether or not a vehicle to be charged supports power line communication (PLC), and a method and system for charging an electric vehicle using the method.

In addition, an embodiment provides a method of obtaining vehicle information during slow charging of an electric vehicle charger, in which not only charging between the charger and a vehicle but also authentication and payment can be automatically performed through power line communication (PLC), and a method and system for charging an electric vehicle using the method.

In addition, an embodiment provides a method of obtaining vehicle information during slow charging of an electric vehicle charger, in which customer demand information (e.g., charging end time prediction information, etc.) can be generated and provided on the basis of additional information (e.g., state of charge (SoC), etc.) obtained through power line communication (PLC), thereby improving customer convenience and satisfaction, and a method and system for charging an electric vehicle using the method.

Embodiments of the present disclosure are not necessarily limited to the above-mentioned matters, and those of ordinary skill in the art to which the present disclosure pertains can clearly understand other embodiments intended and covered by the present disclosure from the following description.

As technical ways for achieving the above-described features and advantages by an embodiment, a method of obtaining vehicle information during slow charging of an electric vehicle charger, and a method and system for charging an electric vehicle using the method may be provided.

In accordance with an embodiment of the present disclosure, the above and other features and advantages can be accomplished by the provision of a method of obtaining vehicle information during slow charging of an electric vehicle charger, the method including (a) transmitting a direct current (DC) method as charging method information to an electric vehicle through power line communication (PLC), (b) obtaining vehicle information from the electric vehicle, (c) terminating PLC with the electric vehicle and performing slow charging of the electric vehicle on the basis of pulse width modulation (PWM) communication, (d) terminating the PWM communication upon completion of slow charging, and (e) resuming the PLC to obtain vehicle information from the electric vehicle.

According to an embodiment, the method may include determining whether alternating current (AC) PLC support determination information related to the electric vehicle is input upon connection to the electric vehicle, transmitting the AC PLC support determination information to a server if the AC PLC support determination information is input, and receiving a determination signal from the server. In such embodiment, the electric vehicle charger may perform the steps (a) to (e) if the determination signal corresponds to a case of an AC PLC non-supporting vehicle.

According to an embodiment, the method may include obtaining vehicle information from the electric vehicle through the PLC if the determination signal corresponds to a case of an AC PLC supporting vehicle.

According to an embodiment, the method may include transmitting an AC method as charging method information to the electric vehicle through PLC if the AC PLC support determination information is not input, determining whether a response is received from the electric vehicle within a preset time, and obtaining vehicle information from the electric vehicle through PLC if a response is received.

According to an embodiment, the method may include terminating the current PLC and performing the steps (a) to (e) if no response is received.

In accordance with another embodiment of the present disclosure, there is provided a method of obtaining vehicle information during slow charging of an electric vehicle charger, the method including determining whether AC PLC support determination information related to the electric vehicle is input, transmitting the AC PLC support determination information to a server if the AC PLC support determination information is input, receiving a determination signal from the server, and obtaining vehicle information by performing one of first to third sequences according to whether or not the AC PLC support determination information is input and the determination signal from the server.

According to an embodiment, the method may include performing the first sequence to obtain vehicle information if the determination signal from the server corresponds to a case of an AC PLC supporting vehicle.

According to an embodiment, the method may include performing the second sequence to obtain vehicle information if the determination signal from the server corresponds to a case of an AC PLC non-supporting vehicle.

According to an embodiment, the method may include performing the third sequence to obtain vehicle information if the AC PLC support determination information is not input.

According to an embodiment, the first sequence may include obtaining vehicle information from the electric vehicle through the PLC.

According to an embodiment, the second sequence may include transmitting a DC method as charging method information to the electric vehicle through PLC, obtaining vehicle information from the electric vehicle, terminating PLC with the electric vehicle and performing slow charging of the electric vehicle on the basis of PWM communication, terminating the PWM communication upon completion of slow charging, and resuming the PLC to obtain vehicle information from the electric vehicle.

According to an embodiment, the third sequence may include transmitting an AC method as charging method information to the electric vehicle through PLC, determining whether a response is received from the electric vehicle within a preset time, and obtaining vehicle information by performing the first sequence or the second sequence according to whether or not a response is received.

In accordance with another embodiment of the present disclosure, there is provided a method of charging an electric vehicle, the method including determining, by the electric vehicle charger, whether AC PLC support determination information related to the electric vehicle is input, transmitting the AC PLC support determination information to a server if the AC PLC support determination information is input, receiving a determination signal from the server, and charging the electric vehicle by performing one of first to third sequences according to whether the AC PLC support determination information is input and the determination signal from the server.

According to an embodiment, the method may include performing slow charging of the electric vehicle by performing the first sequence if the determination signal from the server corresponds to a case of an AC PLC supporting vehicle.

According to an embodiment, the method may include performing slow charging of the electric vehicle by performing the second sequence if the determination signal from the server corresponds to a case of an AC PLC non-supporting vehicle.

According to an embodiment, the method may include performing slow charging of the electric vehicle by performing the third sequence if the AC PLC support determination information is not input.

According to an embodiment, the method may include obtaining vehicle information from the electric vehicle through the PLC, and performing slow charging of the electric vehicle through the PLC.

According to an embodiment, the second sequence may include transmitting a DC method as charging method information to the electric vehicle through PLC, obtaining vehicle information from the electric vehicle, and terminating PLC with the electric vehicle and performing slow charging of the electric vehicle on the basis of PWM communication.

According to an embodiment, the third sequence may include transmitting an AC method as charging method information to the electric vehicle through PLC, determining whether or not a response is received from the electric vehicle within a preset time, and performing slow charging of the electric vehicle by performing the first sequence or the second sequence according to whether or not a response is received.

In accordance with another aspect of the present disclosure, there is provided an electric vehicle charging system implemented such that an electric vehicle charger charges an electric vehicle through slow (AC) charging.

According to an embodiment, the electric vehicle charger may transmit AC PLC support determination information related to the electric vehicle to a server if the AC PLC support determination information is input, receive a determination signal from the server, and perform slow charging of the electric vehicle by performing one of first to third sequences according to whether or not the AC PLC support determination information is input and according to the determination signal.

According to an embodiment, the electric vehicle charger may obtain vehicle information from the electric vehicle through PLC according to the first sequence and perform slow charging of the electric vehicle through the PLC if the determination signal corresponds to a case of an AC PLC supporting vehicle.

According to an embodiment, the electric vehicle charger may transmit a DC method as charging method information to the electric vehicle through PLC according to the second sequence to obtain vehicle information from the electric vehicle, terminate PLC with the electric vehicle, and then perform slow charging of the electric vehicle on the basis of PWM communication if the determination signal corresponds to a case of an AC PLC non-supporting vehicle.

According to an embodiment, the electric vehicle charger may transmit an AC method as charging method information to the electric vehicle through PLC according to the third sequence, and then determine whether or not a response is received from the electric vehicle within a preset time if the AC PLC support determination information is not input, perform slow charging according to the first sequence if a response is received, and perform slow charging according to the second sequence if no response is received.

Specific details according to various examples and embodiments of the present disclosure other than the ways for solving the problems mentioned above can be included in the description and drawings below.

### BRIEF DESCRIPTION OF THE DRAWINGS

The above and other features and other advantages of the present disclosure will be more clearly understood from the following detailed description taken in conjunction with the accompanying drawings, in which:

FIG. 1 is a diagram schematically showing an electric vehicle charging system according to an embodiment of the present disclosure;

FIG. 2 is a flowchart illustrating an operation of the electric vehicle charging system according to an embodiment of the present disclosure at the time of performing a first sequence;

FIG. 3 is a flowchart illustrating an operation of the electric vehicle charging system according to an embodiment of the present disclosure at the time of performing a second sequence;

FIG. 4 is a flowchart illustrating an operation of the electric vehicle charging system according to an embodiment of the present disclosure at the time of performing a third sequence;

FIG. 5 is a flowchart illustrating an entire operation of the electric vehicle charging system according to an embodiment of the present disclosure; and

FIG. 6 is a diagram showing a detailed structure embodiment of the electric vehicle charging system of FIG. 1.

### DETAILED DESCRIPTION OF ILLUSTRATIVE EMBODIMENTS

Advantages and features of the present disclosure and ways of attaining the same can become apparent with reference to embodiments described below in detail in conjunction with the accompanying drawings. The present disclosure, however, is not necessarily limited to the embodiments disclosed hereinafter and may be embodied in many different forms. Rather, these exemplary embodiments are provided so that this disclosure will be through and complete and will fully convey the scope to those skilled in the art. Thus, the full scope of the present disclosure should be defined by the claims.

The shapes, sizes, ratios, angles, numbers, and the like, which are illustrated in the drawings to describe various embodiments of the present disclosure, are merely given by way of example, and therefore, the present disclosure is not necessarily limited to the illustrations in the drawings. The same or extremely similar elements are designated by the same reference numerals throughout the specification. In addition, in the description of the present disclosure, a detailed description of related known technologies can be omitted when it may make the subject matter of the present disclosure rather unclear. In the present specification, when the terms “comprise”, “include”, and the like are used, other elements may be added unless the term “only” is used. An element described in the singular form can be intended to include a plurality of elements unless the context clearly indicates otherwise.

In the interpretation of constituent elements included in various embodiments of the present disclosure, the constituent elements can be interpreted as including an error range even if there is no explicit description thereof.

In the description of various embodiments of the present disclosure, when describing temporal relationships, for example, when the temporal relationship between two actions is described using “after”, “subsequently”, “next”, “before”, or the like, the actions may not occur in succession unless the term “directly” or “just” is used.

In the description of various embodiments of the present disclosure, although terms such as, for example, “first” and “second” may be used to describe various elements, these terms can be merely used to distinguish the same or similar elements from each other. Therefore, in the present specification, an element modified by “first” may be the same as an element modified by “second” within the technical scope of the present disclosure unless mentioned otherwise.

It can be understood that, although the terms “first”, “second”, “A”, “B”, “(a)”, “(b)”, etc., may be used herein to describe various elements of the present disclosure, these terms can be used merely to distinguish one element from another element, and essential, order, or sequence of corresponding elements are not necessarily limited by these terms. It can be understood that when one element is referred to as being “connected to”, “coupled to”, or “access” another element, one element may be “connected to”, “coupled to”, or “access” another element via a further element, although one element may be directly connected to or directly access another element.

“At least one” should be understood to include all combinations of one or more of associated elements. For example, “at least one of first, second, and third elements” means not only the first, second, or third element, but also all combinations of two or more of the first, second, and third elements.

The respective features of various embodiments of the present disclosure may be partially or wholly coupled to and combined with each other, and various technical linkage and driving thereof are possible. These various embodiments may be performed independently of each other, or may be performed in association with each other.

Embodiments of the present disclosure will be described below through the accompanying drawings and examples. Since the scales of the components shown in the drawings can have different scales from actual ones for convenience of description, the scales are not necessarily limited to the scales shown in the drawings.

Hereinafter, a method of obtaining vehicle information during slow charging of an electric vehicle charger, and a method and system for charging an electric vehicle using the same according to embodiments of the present disclosure will be described with reference to the accompanying drawings.

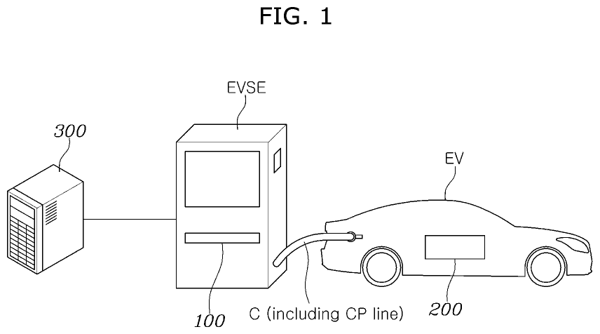

FIG. 1 is a diagram schematically showing an electric vehicle charging system according to an embodiment of the present disclosure.

Referring to FIG. 1, the electric vehicle charging system according to an embodiment of the present disclosure includes a charging controller 100 provided in electric vehicle supply equipment (EVSE), a charging controller 200 provided in an electric vehicle (EV), and a server 300, and the configuration of the electric vehicle charging system is not necessarily limited thereto.

The charging controller 100 (hereinafter, a first charging controller or a charger-side charging controller) installed in the EVSE (or charger) and the charging controller 200 (hereinafter, a second charging controller or a vehicle-side charging controller) provided in the electric vehicle EV (or vehicle) may be connected by a charging cable C.

The charging cable C (or charging connector) may include a control pilot (CP) line. The CP line may be a communication line for adjusting a charging level between the charger EVSE and the vehicle EV or exchanging other information.

The charger EVSE according to the embodiment may be a charger capable of performing slow charging (AC charging) of the electric vehicle EV. For example, the charger EVSE may be a dedicated charger for slow charging. For example, the charger EVSE may be a universal charger capable of performing both slow charging and fast charging (DC charging) and a universal charger in a state of performing slow charging.

The electric vehicle EV according to an embodiment may be an automobile that supplies current induced from a rechargeable energy storage device such as a battery as an energy source of an electric motor, which is a power unit.

However, the electric vehicle EV according to the embodiment of the present disclosure may include a hybrid vehicle having both an electric motor and a general internal combustion engine, and may include not only automobiles but also motorcycles, carts, scooters, and electric bicycles.

According to an embodiment, the charger EVSE may receive information used to determine whether PLC is supported during AC charging (hereinafter referred to as AC PLC support determination information) before charging the vehicle EV. According to an embodiments, the charger EVSE may not be able to receive the AC PLC support determination information.

For example, the charger EVSE may receive user information or vehicle information as the AC PLC support determination information, but the AC PLC support determination information is not limited thereto. For example, the user information may be preset ID information, and the vehicle information may be vehicle model information.

For example, the charger EVSE may directly receive the AC PLC support determination information from a user. Alternatively, the charger EVSE may receive the AC PLC support determination information through an authentication means such as a user authentication card or through communication with the vehicle EV.

The charger EVSE may transmit the received AC PLC support determination information to the server 300 and receive a result of determining whether a vehicle to be charged is a vehicle supporting PLC during AC charging from the server 300.

According to an embodiment, when the charger EVSE is connected to the vehicle EV through the charging cable C, the first charging controller 100 and the second charging controller 200 may exchange data (or information) and perform charging control and the like through a CP line.

The server 300 may communicate with the charger EVSE, determine whether the vehicle to be charged is a vehicle that supports PLC during AC charging on the basis of the AC PLC support determination information transmitted from the charger EVSE, and transmit a determination result to the charger EVSE.

The server 300 may store information on vehicles that support PLC during AC charging (AC PLC supporting vehicles) and information on vehicles that do not support PLC during AC charging (AC PLC non-supporting vehicles).

For example, in a case in which vehicle model information is used as the AC PLC support determination information, the server 300 may classify and store an AC PLC supporting vehicle and an AC PLC non-supporting vehicle on the basis of the vehicle model information.

For example, when user information is used as the AC PLC support determination information, the server 300 may classify and store an AC PLC supporting vehicle and an AC PLC non-supporting vehicle on the basis of the user information.

According to an embodiment, the server 300 may determine whether the vehicle to be charged supports AC PLC on the basis of the AC PLC support determination information, and transmit the determination result (or a determination signal) to the charger EVSE.

For example, the server 300 may output a first determination signal if the vehicle to be charged is an AC PLC-supporting vehicle, and transmit a second determination signal if the vehicle to be charged is an AC PLC non-supporting vehicle.

According to an embodiment, the charger EVSE may perform a different sequence depending on whether the AC PLC support determination information is input, and depending on the determination result of the server 300.

For example, the charger EVSE may perform a first sequence (Sequence A) upon receiving the first determination signal from the server 300, perform a second sequence (Sequence B) upon receiving the second determination signal from the server 300, and perform a third sequence (Sequence C) if the AC PLC support determination information is not received.

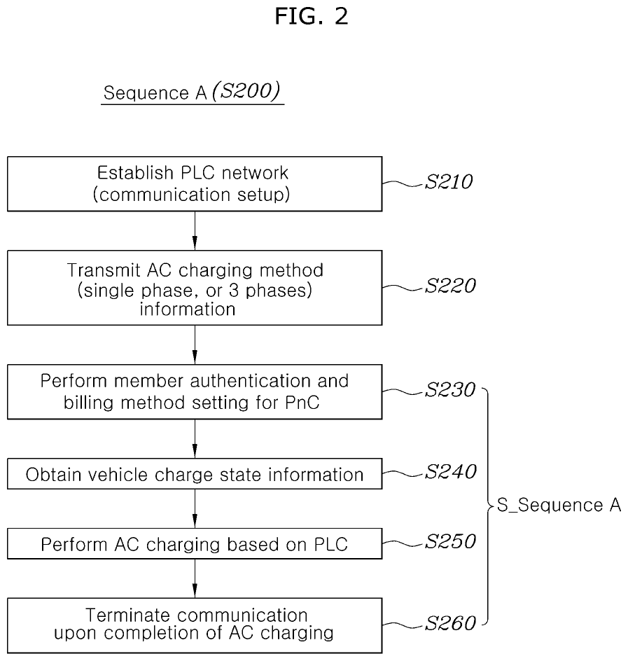

FIG. 2 is a flowchart illustrating an operation (S200) of the electric vehicle charging system according to an embodiment of the present disclosure at the time of performing the first sequence (Sequence A).

Referring to FIGS. 1 and 2, the first charging controller 100 of the charger EVSE may perform power line communication with the second charging controller 200 of the vehicle EV through the CP line to obtain vehicle information and payment information, vehicle charge state information, and the like, and control AC charging. For example, the first charging controller 100 may perform AC charging of the vehicle EV while communicating with the second charging controller 200 according to an AC PLC communication protocol (ISO 15118).

According to an embodiment, the electric vehicle charging system may be implemented to charge the vehicle EV using a Plug and Charge (PnC) charging method. The PnC charging method may be a method in which authentication and billing for charging are automatically performed between the charger EVSE and the vehicle EV.

In a case in which the electric vehicle charging system is implemented to charge the vehicle EV using the PnC charging method in this manner, the first charging controller 100 and the second charging controller 200 may perform authentication and automatic billing while performing power line communication (PLC) through the CP line.

A certificate authentication process, a billing method setting process, and an automatic charge settlement and billing process may be performed between the first charging controller 100 and the second charging controller 200.

Specifically, the first charging controller 100 may perform a communication setup procedure for forming a network for power line communication (PLC) in association with the second charging controller 200 (operation S210).

According to the communication setup procedure, the first charging controller 100 may transmit a PWM signal having a set duty ratio to the second charging controller 200 to inform that charging is performed by AC charging.

Then, the second charging controller 200 may check that the voltage of the CP line is a normal voltage (e.g., 9 V) and that the PWM signal from the first charging controller 100 is a signal for operating in an AC charging mode, and prepare to operate in a PLC charging mode.

Upon completion of the communication setup procedure, the first charging controller 100 may transmit AC charging method information (or input voltage type information) (e.g., single phase or three phases) to the second charging controller 200 (operation S220) such that the second charging controller 200 can charge the vehicle EV according to the AC charging method.

According to an embodiment, transmission of the AC charging method information (operation S220) may be included in the communication setup procedure (operation S210).

After operation S220, the first charging controller 100 may perform member authentication and billing method setting for providing a PnC charging service in association with the second charging controller 200 (operation S230).

Operation S230 can be performed in a case in which the electric vehicle charging system is implemented to charge the vehicle EV using the PnC charging method, and operation S230 may be omitted depending on the embodiment.

After operation S230, the first charging controller 100 may receive and acquire vehicle information (vehicle charge state information) for charging from the second charging controller 200 through PLC (operation S240), and perform AC charging of the vehicle EV through PLC on the basis of the vehicle charge state information (operation S250).

The first charging controller 100 may receive and acquire the vehicle charge state information from the second charging controller 200 while performing AC charging.

For example, the vehicle charge state information may include maximum voltage information, maximum current information, energy reserve expected when the vehicle is fully charged (Full SoC), energy reserve expected at a requested charging end time (Bulk SoC), and the like, but the vehicle charge state information is not necessarily limited thereto.

After operation S250, the first charging controller 100 may terminate communication with the second charging controller 200 upon completion of AC charging (operation S260).

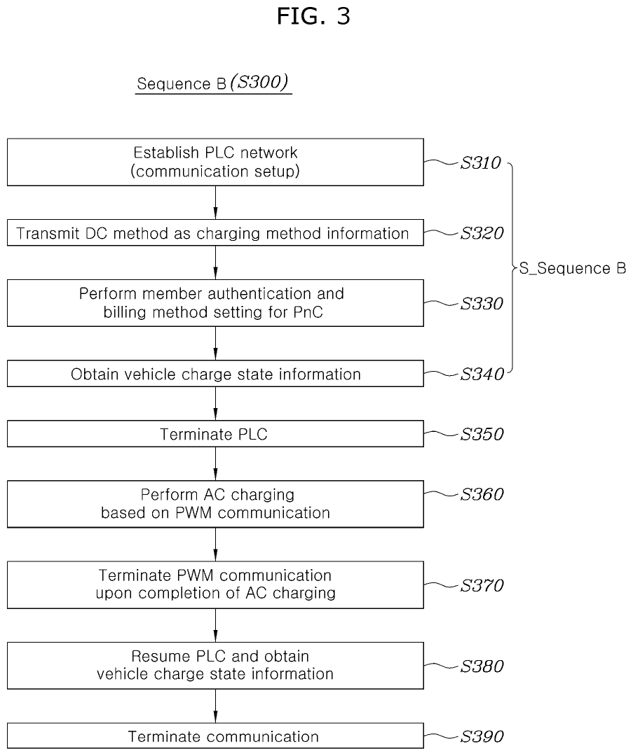

FIG. 3 is a flowchart illustrating an operation (S300) of the electric vehicle charging system according to the embodiment of the present disclosure at the time of performing the second sequence (Sequence B).

Referring to FIGS. 1 and 3, the first charging controller 100 of the charger EVSE may transmit, as a DC method, charging method information to the second charging controller 200 of the vehicle EV through the CP line, and obtain vehicle information, payment information, vehicle charge state information, and the like, while performing PLC with the second charging controller 200.

In addition, upon acquisition of the information, the first charging controller 100 may terminate PLC with the second charging controller 200, and perform pulse width modulation (PWM) communication with the second charging controller 200 to perform AC charging of the vehicle EV.

Upon completion of AC charging of the vehicle EV, the first charging controller 100 may terminate PWM communication, resume PLC with the second charging controller 200 to obtain vehicle information (including vehicle charge state information), and then terminate communication with the second charging controller 200.

According to an embodiment, the electric vehicle charging system may be implemented to charge the vehicle EV using a Plug and Charge (PnC) charging method.

In a case in which the electric vehicle charging system is implemented to charge the vehicle EV using a PnC charging method in this manner, the first charging controller 100 and the second charging controller 200 can perform authentication and automatic billing while performing PLC through the CP line.

Specifically, the first charging controller 100 may perform a communication setup procedure for forming a network for PLC in association with the second charging controller 200 (operation S310).

Because the communication setup procedure in operation S310 can be the same as the communication setup procedure in operation S210 of FIG. 2, a detailed description thereof will be omitted.

Upon completion of the communication setup procedure, the first charging controller 100 may transmit a DC method as charging method information to the second charging controller 200 (operation S320).

After operation S320, the first charging controller 100 may perform member authentication and billing method setting for providing a PnC charging service in association with the second charging controller 200 (operation S330).

Operation S330 can be performed in a case in which the electric vehicle charging system is implemented to charge the vehicle EV using a PnC charging method, and operation S330 may be omitted depending on the embodiment.

After operation S330, the first charging controller 100 may receive and obtain vehicle information (vehicle charge state information) for charging from the second charging controller 200 through PLC (operation S340).

After operation S340, the first charging controller 100 may terminate PLC with the second charging controller 200 upon acquisition of the vehicle charge state information (operation S350), and perform PWM communication with the second charging controller 200 on the basis of the vehicle charge state information to perform AC charging (operation S360).

After operation S360, the first charging controller 100 may terminate PWM communication with the second charging controller 200 upon completion of AC charging (operation S370), resume PLC with the second charging controller 200 to obtain vehicle charge state information (operation S380), and then terminate communication with the second charging controller 200 (operation S390).

According to an embodiment, operation S380 may be performed by repeating the operation of a second subsequence (S_Sequence B) including operations S310 to S340.

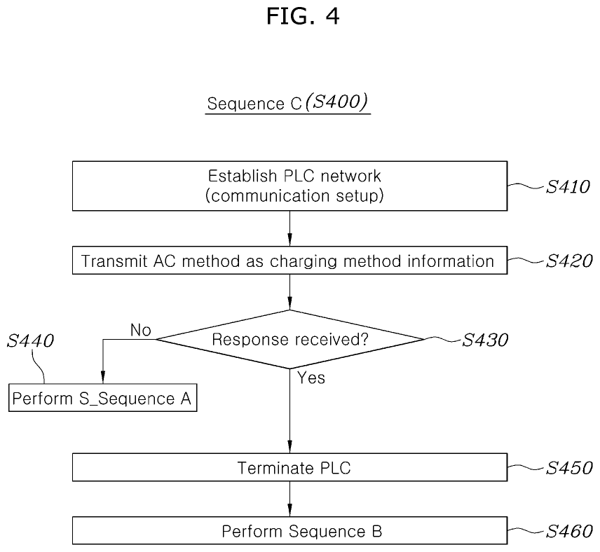

FIG. 4 is a flowchart illustrating an operation (S400) of the electric vehicle charging system according to an embodiment of the present disclosure at the time of performing the third sequence (Sequence C).

Referring to FIGS. 1 and 4, the first charging controller 100 of the charger EVSE may transmit an AC method as charging method information to the second charging controller 200 of the vehicle EV through the CP line, and determine whether a response is received from the second charging controller 200 within a preset time.

Upon receiving a response within the preset time, the first charging controller 100 may perform PLC with the second charging controller 200 of the vehicle EV through the CP line to obtain vehicle information, payment information, and vehicle charge state information, and to control AC charging.

If a response is not received within the preset time, the first charging controller 100 may terminate communication with the second charging controller 200 and perform a communication setup procedure to reconnect with the second charging controller 200.

Thereafter, the first charging controller 100 may transmit the charging method to the second charging controller 200 as DC and perform PLC with the second charging controller 200 to obtain vehicle information, payment information, vehicle charge state information, and the like.

Upon acquisition of the information, the first charging controller 100 may terminate PLC with the second charging controller 200, and perform PWM communication with the second charging controller 200 to perform AC charging of the vehicle EV.

Upon completion of AC charging of the vehicle EV, the first charging controller 100 may terminate PWM communication, resume PLC with the second charging controller 200 to obtain vehicle information (including vehicle charging state information), and then terminate communication with the second charging controller 200.

According to an embodiment, the electric vehicle charging system may be implemented to charge the vehicle EV using a PnC charging method.

In a case in which the electric vehicle charging system is implemented to charge the vehicle EV using a PnC charging method in this manner, the first charging controller 100 and the second charging controller 200 may perform authentication and automatic billing while performing PLC through the CP line.

Specifically, the first charging controller 100 may perform a communication setup procedure for forming a network for PLC in association with the second charging controller 200 (operation S410).

Since the communication setup procedure performed in operation S410 can be the same as the communication setup procedure in operation S210 of FIG. 2, a detailed description thereof will be omitted.

Upon completion of the communication setup procedure, the first charging controller 100 may transmit an AC method (including phase information) as charging method information to the second charging controller 200 (operation S420).

After operation S420, the first charging controller 100 may determine whether a response is received from the second charging controller 200 within a preset time (operation S430).

If a response is received (Yes in operation S430) as a result of determination in operation S430, the first charging controller 100 may perform a first subsequence (S_Sequence A) including operations S230 to S260 (refer to FIG. 2) (operation S440 in FIG. 4). According to an embodiment, the first charging controller 100 may omit the operation of S230.

Accordingly, the first charging controller 100 may obtain vehicle charging state information while performing PLC with the second charging controller 200, and perform AC charging of the vehicle EV based on the obtained vehicle charge state information.

In addition, the first charging controller 100 may terminate communication with the second charging controller 200 upon completion of AC charging. The first charging controller 100 may receive and acquire vehicle charge state information from the second charging controller 200 while performing AC charging.

If a response is not received (No in operation S430) as a result of the determination in operation S430, the first charging controller 100 may terminate the current power line communication (PLC) (operation S450) and perform the second sequence (Sequence B) (refer to FIG. 3) (operation S460 in FIG. 4).

Accordingly, the first charging controller 100 can transmit the charging method as DC to the second charging controller 200, perform PLC with the second charging controller 200 to obtain vehicle information, payment information, vehicle charge state information, and the like, terminate PLC with the second charging controller 200, and perform AC charging of the vehicle EV while performing PWM communication with the second charging controller 200.

In addition, the first charging controller 100 may terminate PWM communication upon completion of AC charging of the vehicle EV, resume PLC with the second charging controller 200 to obtain vehicle information (including vehicle charge state information), and then terminate communication with the second charging controller 200.

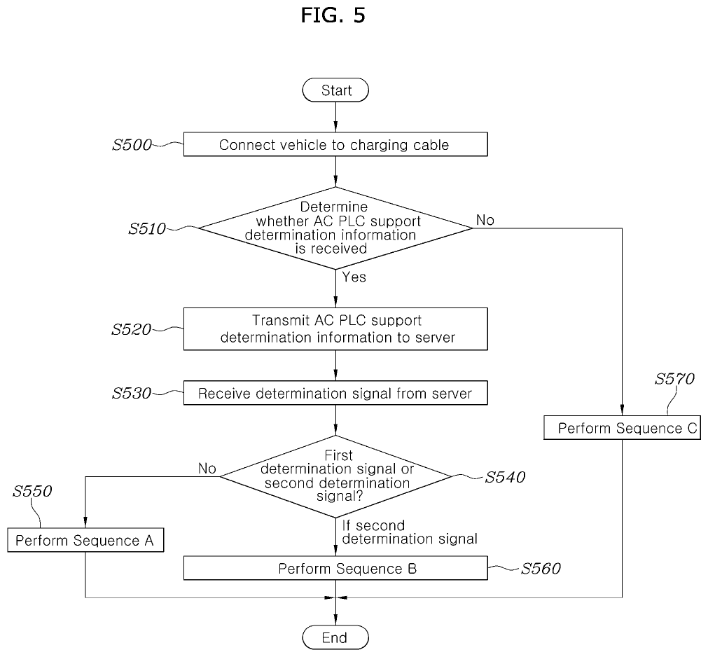

FIG. 5 is a flowchart illustrating an entire operation of the electric vehicle charging system according to an embodiment of the present disclosure.

The step-by-step operation shown in FIG. 5 may be performed by the electric vehicle charging system shown in FIG. 1, and may include the first to third sequences (Sequence A, Sequence B, and Sequence C) described with reference to FIGS. 2 to 4. Hereinafter, detailed descriptions again related to the first to third sequences (Sequence A, Sequence B, and Sequence C) will be omitted.

Referring to FIGS. 1 to 5, the first charging controller 100 of the charger EVSE may determine whether AC PLC support determination information has been input before charging the vehicle EV (operation S510).

For example, in a case in which the charging cable (or connector) C has been connected to the vehicle EV (operation S500), the first charging controller 100 may determine whether AC PLC support determination information has been input.

Upon determining that the AC PLC support determination information has been input (Yes in operation S510) as a result of determination in operation S510, the first charging controller 100 may transmit the AC PLC support determination information to the server 300 (operation S520), and receive a determination signal from the server 300 (operation S530).

Then, the first charging controller 100 may determine whether the received determination signal is the first determination signal or the second determination signal (operation S540).

The first determination signal can be a signal output from the server 300 in a case in which the vehicle to be charged is an AC PLC supporting vehicle, and the second determination signal can be a signal output from the server 300 in a case in which the vehicle to be charged is an AC PLC non-supporting vehicle.

The first charging controller 100 may perform the first sequence (Sequence A) if the determination signal is the first determination signal (operation S550), and perform the second sequence (Sequence B) if the determination signal is the second determination signal (operation S560).

On the other hand, upon determining that the AC PLC support determination information has not been input (No in operation S510) as a result of determination in operation S510, the first charging controller 100 may perform the third sequence (Sequence C) (operation S570).

According to operation of an electric vehicle charging system according to an embodiment of the present disclosure, vehicle information can be obtained before AC charging of the vehicle is performed even for a vehicle that does not support PLC during AC charging.

In addition, according to operation of an electric vehicle charging system according to an embodiment of the present disclosure, even in a situation in which it is impossible to ascertain whether or not a vehicle support PLC during AC charging, vehicle information can be obtained before AC charging of the vehicle is performed.

In addition, because an electric vehicle charging system according to an embodiment of the present disclosure can perform charging using the PnC charging method, not only charging between the charger and the vehicle, but also authentication and payment can be automatically performed through power line communication (PLC).

In addition, an electric vehicle charging system according to an embodiment of the present disclosure can generate and provide customer request information (e.g., charging end time prediction information, etc.) based on vehicle information (e.g., maximum voltage information, maximum current information, Full SoC, Bulk SoC, etc.) obtained through power line communication (PLC), thereby improving customer convenience and satisfaction.

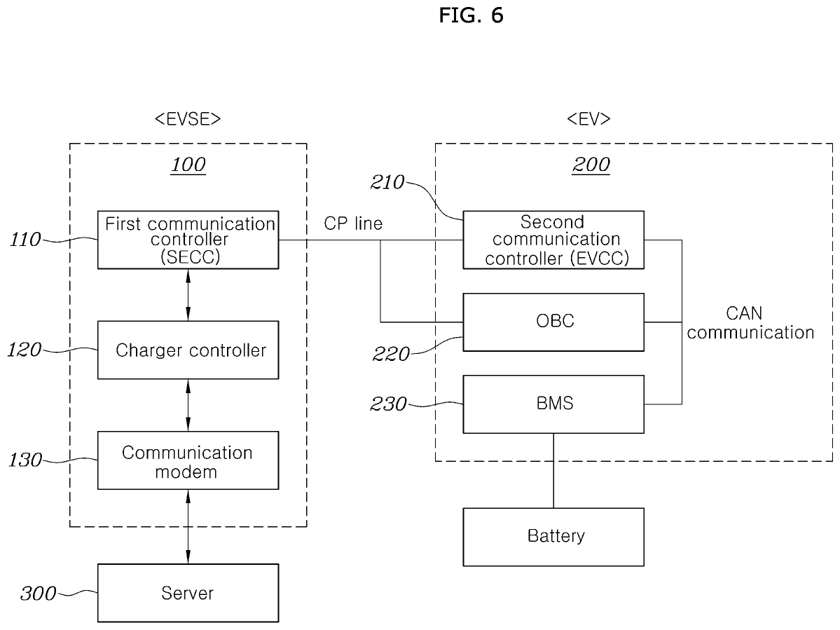

FIG. 6 is a diagram showing a detailed structure of the electric vehicle charging system of FIG. 1, according to an embodiment of the present disclosure.

Referring to FIGS. 1 and 6, the first charging controller 100 of the charger EVSE may include a first communication controller 110, a charger controller 120, and a communication modem 130 for communication with the server 300, but the configuration of the first charging controller 100 is not necessarily limited thereto.

For example, the first communication controller 110 may be represented as a PLC communication controller, a PLC modem, a power supply side (or charger side) communication controller (supply equipment communication controller (SECC)), and the like.

The first communication controller 110 may be connected to the second charging controller 200 on the side of the vehicle EV through a CP line to perform communication. According to an embodiment, the first communication controller 110 may communicate with a second electric vehicle communication controller (EVCC) 210 and an on-board charger (OBC) 220.

The first communication controller 110 may form a network with the second charging controller 200 through a communication setup procedure. The first communication controller 110 may acquire information on the vehicle EV while communicating with the second charging controller 200 through the established network, and control charging of the vehicle EV.

The first communication controller 110 may perform a preset operation according to a determination signal from the charger controller 120.

According to settings (e.g., according to the first determination signal), the first communication controller 110 may communicate with a second charging controller 200 that supports PLC during AC charging. For example, the first communication controller 110 may communicate with the second charging controller 200 according to the AC PLC communication protocol (ISO 15118) to acquire information on the vehicle EV and perform AC charging (or control).

According to settings (e.g., according to the second determination signal), the first communication controller 110 may acquire vehicle information while communicating with a second charging controller 200 that does not support power line communication (PLC) during AC charging, and perform AC charging. In this case, the first communication controller 110 may obtain vehicle information (including vehicle charge state information) through PLC after transmitting a DC as charging method information to the second charging controller 200.

In addition, the first communication controller 110 may terminate PLC upon acquisition of the vehicle information, and then perform AC charging based on or along with using PWM communication.

The first communication controller 110 may terminate PWM communication upon completion of AC charging, and then resume PLC to obtain vehicle information (including vehicle charge state information).

According to settings (e.g., according to the third determination signal), the first communication controller 110 may communicate with a second charging controller 200 for which it is impossible to ascertain whether or not power line communication is supported during AC charging to obtain vehicle information, and perform AC charging. In this case, the first communication controller 110 may transmit an AC as charging method information to the second charging controller 200, communicate with the second charging controller 200 according to the AC PLC communication protocol (ISO 15118) to obtain information on the vehicle EV if there is a response from the second charging controller 200 within a preset time, and perform AC charging.

The first communication controller 110 may terminate the current power line communication (PLC) if there is no response from the second charging controller 200 within the preset time after transmitting the AC as charging method information to the second charging controller 200. Then, the first communication controller 110 may terminate the current power line communication (PLC), transmit a DC as charging method information to the second charging controller 200, and then obtain vehicle information (including vehicle charge state information) through PLC.

In addition, the first communication controller 110 may terminate PLC upon acquisition of the vehicle information, and then perform AC charging based on or along with using PWM communication.

The first communication controller 110 may terminate PWM communication upon completion of AC charging, and then resume PLC to obtain vehicle information (including vehicle charge state information).

The first communication controller 110 may provide the obtained vehicle information to the charger controller 120.

When the charging cable C is connected to the vehicle EV, the charger controller 120 may determine whether AC PLC support determination information is input.

If the AC PLC support determination information is not input, the charger control unit 120 may transmit the third determination signal to the first communication controller 110 such that the first communication controller 110 performs the operation according to the third sequence (Sequence C).

If the AC PLC support determination information is input, the charger controller 120 may transmit the AC PLC support determination information to the server 300 and receive the first determination signal or the second determination signal from the server 300.

The charger control unit 120 may transmit the first determination signal to the first communication controller 110 such that the first communication controller 110 performs the operation according to the first sequence (Sequence A), and transmit the second determination signal to the first communication controller 110 such that the first communication controller 110 performs the operation according to the second sequence (Sequence B).

The second charging controller 200 of the vehicle EV may include the second communication controller 210, the on-board charger (OBC) 220, and a battery management system (BMS) 230, but the configuration of the second charging controller 200 is not necessarily limited thereto.

The second communication controller 210, the OBC 220, and the BMS 230 may be connected to each other through controller area network (CAN) communication, but the present disclosure is not necessarily limited thereto.

The second communication controller 210 can transmit vehicle information to the second communication controller 210 while performing power line communication (PLC) with the first charging controller 100 through the CP line, and perform (or control) AC charging of the battery of the vehicle EV.

The second communication controller 210 may be represented as a vehicle charging management system (VCMS).

The OBC 220 may perform AC charging of the battery of the vehicle EV while performing PWM communication with the first charging controller 100 through the CP line.

The BMS 230 can be a general battery management system, and can charge the battery of the vehicle EV while communicating with the second communication controller 210 and the OBC 220.

According to embodiments of the present disclosure, it is possible to provide a method of obtaining vehicle information during slow charging of an electric vehicle charger, and a method and system for charging an electric vehicle using the same.

According to an operation of the electric vehicle charging system according to embodiments of the present disclosure, it is possible to obtain vehicle information before AC charging of a vehicle is performed even for a vehicle that does not support power line communication (PLC).

In addition, according to an operation of the electric vehicle charging system according to embodiments of the present disclosure, it is possible to obtain vehicle information before AC charging of a vehicle is performed even in a situation in which it is not possible to ascertain whether or not a vehicle supports power line communication (PLC) during AC charging.

In addition, the electric vehicle charging system according to embodiments of the present disclosure can perform charging according to a PnC charging method, and thus not only charging between a charger and a vehicle but also authentication and payment can be automatically performed through power line communication (PLC).

In addition, an electric vehicle charging system according to embodiments of the present disclosure can generate and provide customer demand information (e.g., charging end time prediction information, etc.) based on vehicle information (e.g., maximum voltage information, maximum current information, full SoC, bulk SoC, etc.) obtained through power line communication (PLC), thereby improving customer convenience and satisfaction.

The effects of embodiments of the present disclosure are not necessarily limited to the effects mentioned above, and other effects not mentioned can be clearly understood by those skilled in the art from the description below.

Although the embodiments of the present disclosure have been described in more detail with reference to the accompanying drawings, the present disclosure is not necessarily limited to these embodiments and may be variously modified and implemented without departing from the technical spirit of the present disclosure. Therefore, the embodiments disclosed in this specification are not necessarily intended to limit the technical spirit of the present disclosure, but to explain, and the scope of the technical spirit of the present disclosure is not necessarily limited by these embodiments. Therefore, it should be understood that the embodiments described above are illustrative in all respects and not necessarily restrictive. The protection scope of the present disclosure should be construed according to the claims, and all technical ideas within the equivalent range should be construed as being included in the scope of the present disclosure.

What is claimed is:

1. A method of obtaining vehicle information during alternating current (AC) charging of an electric vehicle through an electric vehicle charger, the method comprising:
determining whether AC power line communication (PLC) is supported;
transmitting, when the AC PLC is not supported, a direct current (DC) method as charging method information to the electric vehicle through power line communication (PLC);
obtaining vehicle information from the electric vehicle;
terminating PLC with the electric vehicle and performing AC charging of the electric vehicle with pulse width modulation (PWM) communication;
terminating the AC charging;
terminating the PWM communication; and
resuming the PLC to obtain vehicle information from the electric vehicle.

2. The method of claim 1, wherein the determining whether the AC PLC is supported comprises:
determining whether AC PLC support determination information related to the electric vehicle is input upon connection to the electric vehicle;
transmitting the AC PLC support determination information to a server when the AC PLC support determination information is input; and
receiving a determination signal from the server.

3. The method of claim 1, further comprising:
obtaining, when the AC PLC is supported, vehicle information from the electric vehicle through the PLC.

4. The method of claim 2, comprising:
transmitting an AC method as charging method information to the electric vehicle through PLC when the AC PLC support determination information is not input;
determining whether a response is received from the electric vehicle within a preset time;
obtaining vehicle information from the electric vehicle through PLC when a response is received; and
terminating, when no response is received, a current PLC and performing the steps of transmitting the DC method, obtaining the vehicle information, terminating PLC, performing the AC charging, terminating the AC charging, terminating the PWM communication, and resuming the PLC.

5. A method of obtaining vehicle information during alternating current (AC) charging of an electric vehicle through an electric vehicle charger, the method comprising:
determining whether AC power line communication (PLC) support determination information related to the electric vehicle is input;
transmitting the AC PLC support determination information to a server when the AC PLC support determination information is input;
receiving a determination signal from the server; and
obtaining vehicle information by performing one of first to third sequences according to whether or not the AC PLC support determination information is input and according to the determination signal received from the server.

6. The method of claim 5, comprising:
performing the first sequence to obtain vehicle information when the determination signal from the server corresponds to a case of an AC PLC supporting vehicle; and
performing the second sequence to obtain vehicle information when the determination signal from the server corresponds to a case of an AC PLC non-supporting vehicle.

7. The method of claim 5, further comprising performing the third sequence to obtain vehicle information when the AC PLC support determination information is not input.

8. The method of claim 5, wherein the first sequence comprises obtaining vehicle information from the electric vehicle through the PLC.

9. The method of claim 5, wherein the second sequence comprises:
transmitting a DC method as charging method information to the electric vehicle through PLC;
obtaining vehicle information from the electric vehicle;
terminating PLC with the electric vehicle and performing AC charging of the electric vehicle with pulse width modulation (PWM) communication;
terminating the AC charging and terminating the PWM communication; and
resuming the PLC to obtain vehicle information from the electric vehicle.

10. The method of claim 5, wherein the third sequence comprises:
transmitting an AC method as charging method information to the electric vehicle through PLC;
determining whether a response is received from the electric vehicle within a preset time; and
obtaining vehicle information by performing the first sequence or the second sequence according to whether or not a response is received.

11. A method of charging an electric vehicle by an electric vehicle charger through alternating current (AC) charging, the method comprising:
determining, by the electric vehicle charger, whether AC power line communication (PLC) support determination information related to the electric vehicle is input;
transmitting the AC PLC support determination information to a server in response to the AC PLC support determination information being input;
receiving a determination signal from the server; and
charging the electric vehicle by performing one of first to third sequences according to whether the AC PLC support determination information is input and according to the determination signal received from the server.

12. The method of claim 11, comprising:
performing AC charging of the electric vehicle by performing the first sequence in response to the determination signal from the server corresponding to a case of an AC PLC supporting vehicle; and
performing AC charging of the electric vehicle by performing the second sequence in response to the determination signal from the server corresponding to a case of an AC PLC non-supporting vehicle.

13. The method of claim 11, comprising performing AC charging of the electric vehicle by performing the third sequence in response to the AC PLC support determination information not being input.

14. The method of claim 11, comprising:
obtaining vehicle information from the electric vehicle through the PLC; and
performing slow charging of the electric vehicle through the PLC.

15. The method of claim 11, wherein the second sequence comprises:
transmitting a DC method as charging method information to the electric vehicle through PLC;
obtaining vehicle information from the electric vehicle; and
terminating PLC with the electric vehicle and performing AC charging of the electric vehicle along with pulse width modulation (PWM) communication.

16. The method of claim 11, wherein the third sequence comprises:
transmitting an AC method as charging method information to the electric vehicle through PLC;
determining whether or not a response is received from the electric vehicle within a preset time; and
performing AC charging of the electric vehicle by performing the first sequence or the second sequence according to whether or not a response is received.

17. An electric vehicle charging system for an electric vehicle that comprises an electric vehicle charger configured to charge the electric vehicle using alternating current (AC) charging;
wherein the electric vehicle charger is further configured to transmit AC power line communication (PLC) support determination information related to the electric vehicle to a server when the AC PLC support determination information is input;
wherein the electric vehicle charger is further configured to receive a determination signal from the server; and
wherein the electric vehicle charger is further configured to perform AC charging of the electric vehicle by performing one of first to third sequences according to whether or not the AC PLC support determination information is input and according to the determination signal.

18. The system of claim 17, wherein the electric vehicle charger is further configured to obtain vehicle information from the electric vehicle through PLC according to the first sequence, and wherein the electric vehicle charger is further configured to perform slow charging of the electric vehicle through the PLC when the determination signal corresponds to a case of an AC PLC supporting vehicle.

19. The system of claim 18, wherein the electric vehicle charger is further configured to transmit a DC method as charging method information to the electric vehicle through PLC according to the second sequence to obtain vehicle information from the electric vehicle;
wherein the electric vehicle charger is further configured to terminate PLC with the electric vehicle; and
wherein the electric vehicle charger is further configured to perform AC charging of the electric vehicle based on pulse width modulation (PWM) communication when the determination signal corresponds to a case of an AC PLC non-supporting vehicle.

20. The system of claim 19, wherein the electric vehicle charger is further configured to transmit an AC method as charging method information to the electric vehicle through PLC according to the third sequence;
wherein the electric vehicle charger is further configured to determine whether or not a response is received from the electric vehicle within a preset time when the AC PLC support determination information is not input;
wherein the electric vehicle charger is further configured to perform AC charging according to the first sequence when a response is received; and
wherein the electric vehicle charger is further configured to perform AC charging according to the second sequence when no response is received.
